(19) United States
(12) Patent Application Publication
(10) Pub. No.: US 2005/0093778 A1
(43) Pub. Date: May 5, 2005

(54) Panel driving method and apparatus

(76) Inventors: Joon-Koo Kim, Asan-si (KR); Nam-Sung Jung, Yongin-si (KR)

Correspondence Address: McGuire Woods LLP;Suite 1800, 1750 Tysons Boulevard, McLean, VA, 22102, US

(21) Appl. No.: 10/962,715

(22) Filed: Oct. 13, 2004

(30) Foreign Application Priority Data
Oct. 30, 2003 (KR) 2003-76233

(51) Int. Cl. G09G 3/28

(52) U.S. Cl. 345/60

(57) ABSTRACT

A panel driving method includes performing an addressing operation in scan lines only when at least one or more subfield data to be turned on exist in the scan lines in at least one or more subfields.

This application claims the benefit of Korean Patent Application No. 2003-76233 filed on Oct. 30, 2003, which is hereby incorporated by reference for all purposes as if fully set forth herein.

### BACKGROUND OF THE INVENTION

1. Field of the Invention

The present invention relates to a method for driving a panel in which images are displayed by transmitting sustain pulses to an electrode structure that constitutes display cells for a plasma display panel (PDP).

2. Discussion of the Related Art

FIG. 1 is a perspective view of a conventional three-electrode surface discharge type PDP.

Referring to FIG. 1, the conventional frontal discharge PDP 1 includes address electrodes Aₗ, . . . , Aₘ, front and rear dielectric layers 102 and 110, Y electrodes Yₗ, . . . , Yₙ, X electrodes Xₗ, . . . , Xₙ, a fluorescent layer 112, partition walls 114, and an MgO layer 104 as a protective layer, all between a front glass substrate 100 and a rear glass substrate 106.

The address electrodes Aₗ, . . . , Aₘ are formed in a predetermined pattern on an upper surface of the rear glass substrate 106. The rear dielectric layer 110 covers the address electrodes Aₗ, . . . , Aₘ and the upper surface of the rear glass substrate 106. The partition walls 114 are formed on the rear dielectric layer 110, parallel to the address electrodes Aₗ, . . . , Aₘ . The partition walls 114 define discharge regions of each display cell, and prevent optical interference between the display cells. The fluorescent layers 112 are disposed on the rear dielectric layer 110 and on sides of the partition walls 114.

The X electrodes Xₗ, . . . , Xₙ and the Y electrodes Yₗ, . . . , Yₙ are formed on a lower surface of the front glass substrate 100, and they are orthogonal to the address electrodes A₁, . . . , Aₘ. The X electrodes Xₗ, . . . Xₙ and the Y electrodes Yₗ, . . . , Yₙ have transparent electrodes Xₙₐ and Yₙₐ, formed of a transparent conductive material such as an indium tin oxide (ITO), and metal electrodes X_{nb} and Y_{nb}, for increasing conductivity, respectively. The front dielectric layer 102 covers the X electrodes Xₗ, . . . , Xₙ and the Y electrodes Yₗ, . . . , Yₙ. The MgO layer 104, which protects the panel 1 from a strong electric field, is disposed on the front dielectric layer 102. A plasma forming gas is sealed in a discharge space 108.

A conventional method of driving a PDP described above includes sequentially resetting, addressing, and display sustaining in a plurality of subfields. During the resetting, display cell wall charges are uniformly removed. During the addressing, charge states of selected cells and unselected cells are defined. During the display sustaining, a display discharge is performed in the selected cells. During a display discharge, the plasma forming gas generates plasma. The plasma generates ultraviolet rays that excite the fluorescent layer 112 to emit light, thereby producing a visible image.

FIG. 2 is a block diagram of a conventional driving device of the PDP depicted in FIG. 1.

Referring to FIG. 2, the conventional driving device of the PDP 1 includes an image processing unit 200, a logic control unit 202, an address driving unit 206, an X driving unit 208, and a Y driving unit 204. The image processing unit 200 generates internal image signals of 8-bit red (R), green (G), and blue (B) image data, clock signals, and vertical and horizontal synchronization signals by transforming external analogue signals into digital signals. The logic control unit 202 generates driving control signals S_{A}, S_{Y}, and S_{X} according to the internal image signals generated by the image processing unit 200. The address driving unit 206 processes the address signal S_{A}, generates display data signals, and transmits those signals to the address electrodes. The X driving unit 208 processes the X driving control signal S_{X} and transmits it to the X electrodes. The Y driving unit 204 processes the Y driving control signal S_{Y} and transmits it to the Y electrodes. U.S. Pat. No. 5,541,618 discloses an address-display separation (ADS) driving method generally used to drive a PDP such as PDP 1.

FIG. 3 shows a conventional Address-Display Separation driving method for the Y electrodes of the PDP depicted in FIG. 1.

Referring to FIG. 3, each unit frame may be divided into a predetermined number of subfields, such as eight fields SF1 through SF8, to realize a time division gray scale display. Also, the subfields SF1 through SF8 may be further divided into reset phases (not shown), address phases A1 through A8, and sustain discharge phases S1 through S8.

During each address phase A1 through A8, display data signals are sequentially transmitted to the address electrodes Aₗ, Aₗ, . . . Aₘ₋₁, and Aₘ and corresponding scan pulses are sequentially transmitted to the Y electrodes Yₗ, . . . , Yₙ.

During each sustain discharge phase S1 through S8, discharge pulses are alternately transmitted to the X electrodes Xₗ, . . . , Xₙ and the Y electrodes Yₗ, . . . , Yₙ, thereby creating sustain discharges in the display cells in which wall charges are accumulated during the address phases A1 through A8.

PDP brightness is proportional to the period of the sustain discharge pulse during the sustain discharge phases S1 through S8. If one frame for forming a picture is divided into eight subfields having 256 gray scales, each subfield may have a sustain pulse with a period of 1T, 2T, 4T, 8T, 16T, 32T, 64T, or 128T, where T is a unit of period. For example, to obtain a brightness of 133 gray scales, the cells may be sustain discharged by addressing for one unit period (1 gray scale), three unit periods (4 gray scales), and eight unit periods (128 gray scales).

The period of the sustain discharge assigned to each subfield may be varied according to the weight of the subfield depending on an automatic power control (APC) step. Also, the period of the sustain discharge to be assigned to each subfield may vary according to a gamma characteristic and a panel characteristic. For example, the gray scale 8 of subfield S4 may be reduced to 6 and the gray scale 32 of subfield S6 may be increased to 34. Also, the number of subfields constituting a frame may change according to a design specification.

FIG. 4 is a timing diagram for explaining an example of a driving signal of the panel depicted in FIG. 1. The timing diagram shows an ADS driving signal transmitted to is addressing electrodes Aₗ, . . . , Aₘ, common electrodes Xl, . . . , Xn, and scan electrodes Yₗ, . . . , Yₙ in a subfield SFₙ of an AC PDP. Referring to FIG. 4, one subfield Sₙ includes a reset period PR, an address period PA, and a sustain discharge period PS.

In the reset period PR, a reset pulse is applied to all scan lines to uniformly set display cell wall charges throughout the panel. During the address period PA, a biased voltage Vₑ is applied to the common electrodes Xₗ, . . . , Xₙ, and display cells are selected by simultaneously turning on pairs of the scan electrodes Yₗ, . . . , Yₙ and the address electrodes Aₗ, . . . , Aₘ, respectively, at display cell locations where an image is to be displayed. During the sustain discharge period PS, a sustain pulse V_{S} is alternately transmitted to the common electrodes Xₗ, . . . , Xₙ and all the scan electrodes Yₗ, . . . , Yₙ and a low level voltage V_{G} is applied to the address electrodes Aₗ, . . . , Aₘ.

The time required for the addressing period PA poses a problem for obtaining a high resolution in a PDP.

PDP brightness may be controlled by the number of sustain discharge pulses. In one subfield or one TV field, brightness increases as the number of pulses increase. Therefore, the time assigned to the sustain discharge period may be extended to improve brightness and express a variety of gray scales. However, for driving a PDP, since one TV field is fixed to 69 Hz and 16.67 ms, in order to increase the duration of the sustain discharge period, the address period may be shortened.

### SUMMARY OF THE INVENTION

The present invention provides a panel driving device and method for reducing the amount of time required for an addressing phase.

Additional features of the invention will be set forth in the description which follows, and in part will be apparent from the description, or may be learned by practice of the invention.

The present invention discloses a method of driving a panel comprising performing an addressing operation in a scan line only when the scan line had subfield data to be turned on.

The present invention also discloses a method of driving a panel that displays image frames by dividing a frame into a plurality of subfields, and further dividing a subfield into at least an address period and a sustain discharge period, comprising transforming red (R), green (G), blue (B) gray scale data into subfield data, determining a scan line having subfield data to be turned on, and transmitting a scan pulse to the scan line only when the scan line has data to be turned on.

The present invention also discloses a panel driving device, comprising an address data generating unit, an address data detection unit, and a scan pulse generating unit. The address data generating unit generates subfield data based on red (R), green (G), blue (B) gray scale data. The address data detection unit detects subfield data to be turned on in each corresponding scan line from the subfield data and outputs the detection result as a control signal. The scan pulse generating unit generates a scan pulse for a scan line according to the control signal. The address data generating unit outputs the subfield data to an address driving unit according to the control signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of a conventional three-electrode surface discharge type PDP.

FIG. 2 is a block diagram of a conventional driving device of the PDP depicted in FIG. 1.

FIG. 3 shows a conventional address-display separation driving method of the Y electrodes of the PDP depicted in FIG. 1.

FIG. 4 is a timing diagram for explaining an example of a driving signal of the PDP depicted in FIG. 1.

FIG. 5 is a block diagram for a logic control unit depicted in FIG. 3.

FIG. 6 is a block diagram for describing a panel driving device according to an exemplary embodiment of the present invention.

FIG. 7 is an example of a subfield data for describing a panel driving method according to an embodiment of the present invention.

FIG. 8A is a waveform diagram illustrating scan pulses transmitted to scan lines according to a conventional panel driving method for the subfield data depicted in FIG. 7.

FIG. 8B is a waveform diagram illustrating scan pulses transmitted to scan lines according to a panel driving method according to an exemplary embodiment of the present invention for the subfield data depicted in FIG. 7.

FIG. 9 is a second example of subfield data for describing a panel driving method according to an exemplary embodiment of the present invention.

FIG. 10 is a waveform diagram illustrating scan pulses transmitted to scan lines according to panel driving method according to an exemplary embodiment of the present invention for the subfield data depicted in FIG. 9.

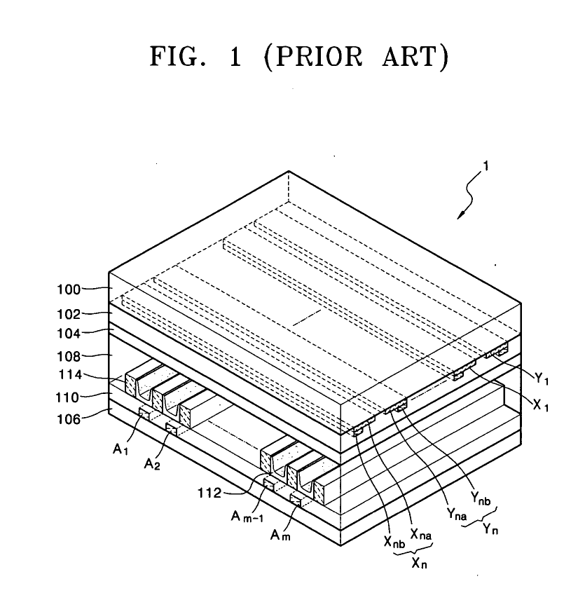

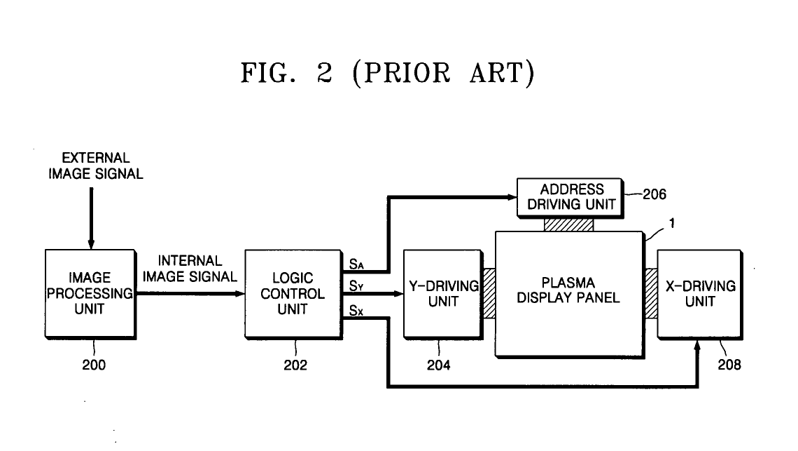

### DETAILED DESCRIPTION OF THE INVENTION

The present invention will now be described with reference to the accompanying drawings in which exemplary embodiments of the invention are shown. This invention may be, however, embodied in many different forms and should not be construed as being limited to the embodiments set forth herein. Rather, these embodiments are provided so that this disclosure is thorough and complete and fully conveys the concept of the invention to those skilled in the art.

A basic concept of the a method of driving a panel according to the present invention is that a scanning may be performed when there is at least one or more subfield data to be turn-on in the horizontal scan line.

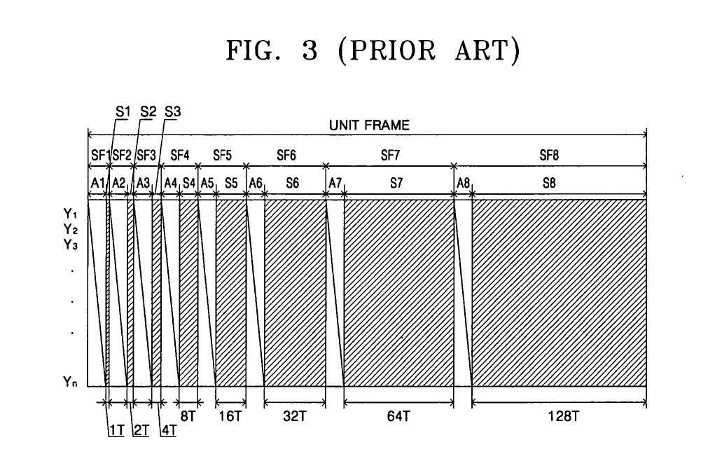

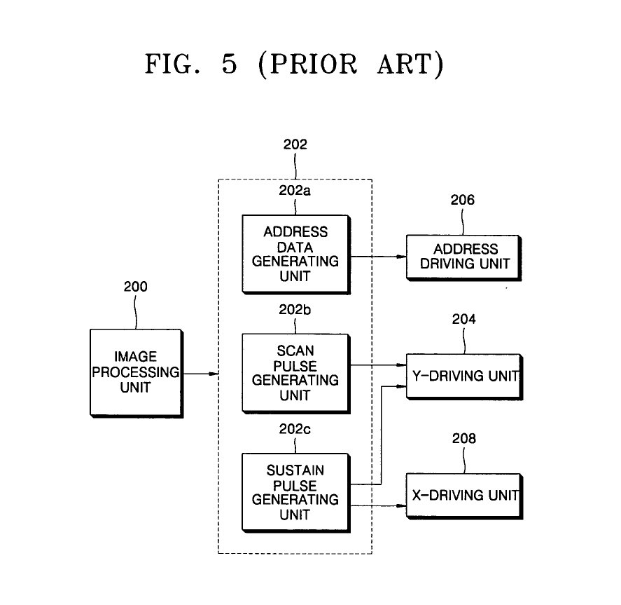

FIG. 5 is a block diagram for describing a logic control unit 202 depicted in FIG. 3. Referring to FIG. 5, the logic control unit comprises an address data generating unit 202a, a scan pulse generating unit 202b, and a sustain pulse generating unit 202c. The address data generating unit 202a receives RGB gray scale information from an image processing unit 200, and outputs that information to an address driving unit 206 after processing it into subfield data. The scan pulse generating unit 202b generates a scan pulse to write the subfield information to each subfield. The sustain pulse generating unit 202c alternately transmits the sustain pulse to the Y electrode and the X electrode.

Conventionally, the addressing operation is performed by transmitting the scan pulse to all scan lines in each subfield regardless of the existence of sub field data in each scan line.

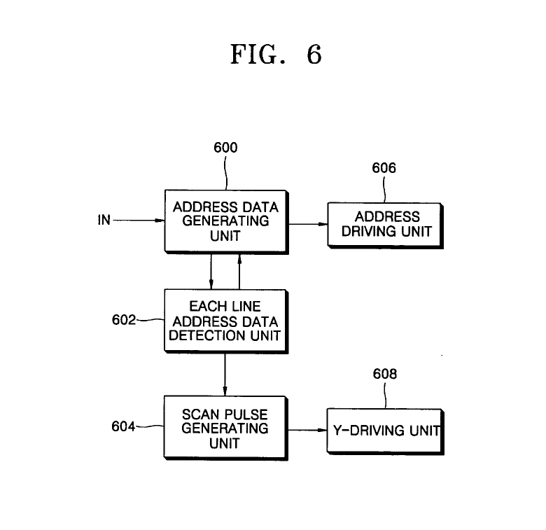

FIG. 6 is a block diagram of a panel driving device according to an exemplary embodiment of the present invention. The panel driving device comprises an address data generating unit 600, an address data detection unit 602, a scan pulse generating unit 604, an address driving unit 606, and a Y driving unit 608.

The address data generating unit 600 processes inputted RGB gray scale information into subfield data and outputs that subfield data to the address data detection unit 602, which controls the subfield data output to the address driving unit 606.

When one frame constituting one picture is expressed in 8 subfields and 256 gray scales, different numbers of sustain pulses may be assigned in a ratio of 1:2:4:8:16:32:64:128 to each subfield. For example, to obtain a brightness of 133 gray scales in a display cell, the address data generating unit 600 addresses the display cell to the first subfield (1 gray scale), the third subfield (4 gray scales), and the eighth subfield (128 gray scales).

The scan pulse generating unit 604 generates scan pulses under the control of the address data detection unit 602 to write the subfield data to each scan line in each subfield.

The address data detection unit 602 detects the existence of subfield data in each corresponding scan line, and outputs the detection results to the address data generating unit 600 and the scan pulse generating unit 604. When data for at least one subfield is detected in the horizontal scan line, the address data are outputted to the address driving unit 606, and the scan pulses are outputted to the Y driving unit 608, simultaneously.

Though not shown in FIG. 6, an image information unit performing a gamma correction or dithering by error diffusion before the RGB data are transmitted to the address data generating unit 600 may also be included.

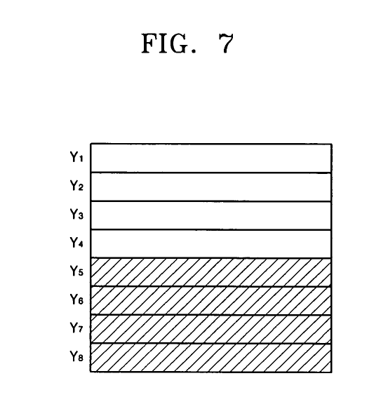

FIG. 7 is an example of subfield data for describing a panel driving method according to an exemplary embodiment of the present invention. For ease of explanation, only 8 scan lines Y₁ though Y₈ are used.

Referring to FIG. 7, subfield data to be turned on exists in the first through fourth scan lines Y₁ through Y₄, but there is no subfield data to be turned on in the fifth through eighth lines Y₅ through Y₈.

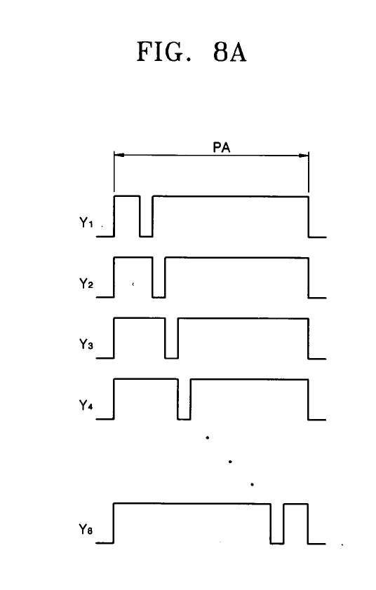

FIG. 8A is a waveform diagram illustrating scan pulses transmitted to scan lines according to a conventional panel driving method for the subfield data depicted in FIG. 7.

FIG. 8B is a waveform diagram illustrating scan pulses transmitted to scan lines according to a panel driving method of an exemplary embodiment of the present invention for the subfield data depicted in FIG. 7.

As shown by the address period of FIG. 8A, conventionally, the addressing operation is performed by sequentially transmitting scan pulses to all scan lines, regardless of whether each scan line has subfield data to be turned on.

According to an exemplary embodiment of the present invention, however, the address operation is performed by transmitting scan pulses to only those scan lines having subfield data to be turned on. As shown in FIG. 8B, scan pulses are transmitted to the scan lines Y₁ through Y₄ only since they have subfield data to be turned on, but scan pulses are not transmitted to the scan lines Y₅ through Y₈ since they do not have subfield data to be turned on. Accordingly, this address period PA finishes after transmitting the scan pulse to the scan line Y₄. Compared to the conventional panel driving method, the address period PA is shorter.

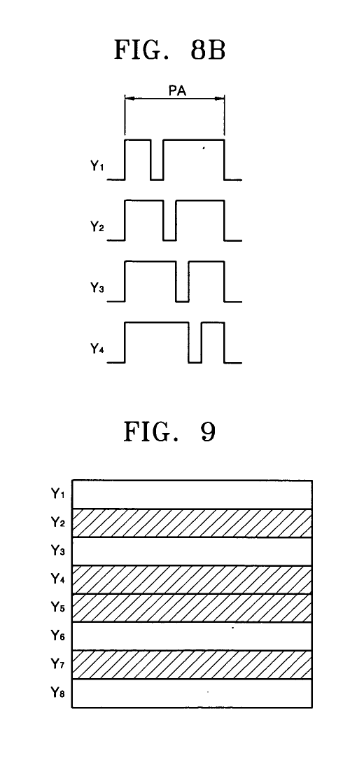

FIG. 9 is another example a subfield data for describing a panel driving method according to an exemplary embodiment of the present invention. Here, subfield data to be turned on exists in the scan lines Y₁, Y₃, Y₆, and Y₈, but no subfield data exists in the scan lines Y₂, Y₄, Y₅, and Y₇.

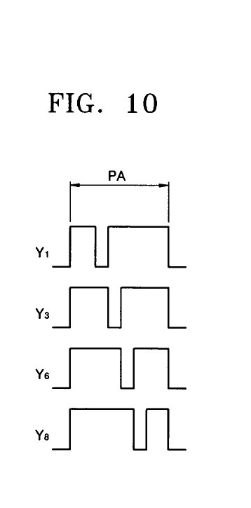

FIG. 10 is a waveform diagram illustrating scan pulses transmitted to scan lines according to a panel driving method of an exemplary embodiment of the present invention for the subfield data depicted in FIG. 9. Scan pulses are not transmitted to the scan lines Y₂, Y₄, Y₅, and Y₇ because they have no subfield data to be turned on. Consequently, the address period PA may be shortened.

As described with reference to the FIG. 8B and FIG. 10, according to an exemplary embodiment of the present invention, the time required for the address period PA may be shortened by addressing only those scan lines that have subfield data to be turned on.

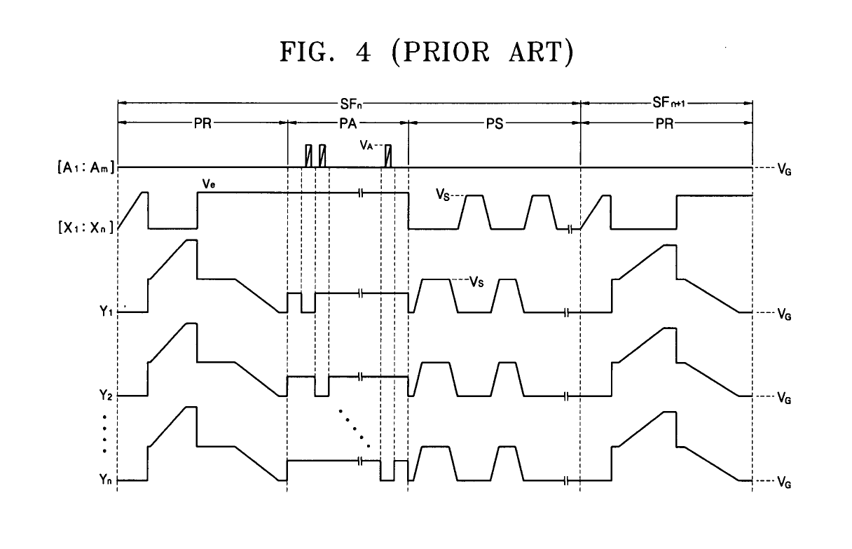

Also, in a panel driving method according to an exemplary embodiment of the present invention, subfields without any data to be turned on may be omitted. Referring to FIG. 4, each subfield SF comprises a reset period PR, an address period PA, and a sustain discharge period PS. If no subfield data exists in a single subfield SFₙ, scan pulses are not transmitted during the address period PA, and cells are not sustain discharged. Therefore, such a subfield may be omitted, which may increase the degree of freedom for design by utilizing the time corresponding to the omitted phase.

According to the above descriptions, the present invention may have the following advantages.

First, time required for an address period may be reduced by only addressing scan lines having data to be turned on. Image quality may be improved by assigning the time reduced from the addressing phase to the sustaining phase.

Second, the power consumption for addressing and the heat generation of the scan driving circuit may be reduced by omitting the transmissions of unnecessary scan pulses.

Third, when no subfield data exists in all scan lines in the subfield, the whole subfield may be omitted, which may increase the freedom of designing panel driving methods because that extra time may be used for other driving operations, such as increasing the length of a sustain discharge period.

While this invention has been shown and described with reference to a PDP, it may be utilized in any panel using an ADS driving method.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A panel driving method, comprising:
performing an addressing operation in a scan line only when the scan line has subfield data to be turned on.

2. The method of claim 1, further comprising:
omitting a subfield having no subfield data to be turned on.

3. The method of claim 1, further comprising:
ending an address period after addressing a last scan line; and
starting a sustain discharge period after the address period.

4. A method of driving a panel that displays image frames by dividing a frame into a plurality of subfields, and further dividing a subfield into at least an address period and a sustain discharge period, comprising:
transforming red (R), green (G), blue (B) gray scale data into subfield data;
determining a scan line having subfield data to be turned on; and
transmitting a scan pulse to the scan line only when the scan line has data to be turned on.

5. The method of claim 4, further comprising:
ending an address period after transmitting a scan pulse to a last scan line; and
starting a sustain discharge period after the address period.

6. The method of claim 4, further comprising:
omitting a subfield having no subfield data to be turned on.

7. A panel driving device, comprising:
an address data generating unit;
an address data detection unit; and
a scan pulse generating unit,
wherein the address data generating unit generates subfield data based on red (R), green (G), blue (B) gray scale data,
wherein the address data detection unit detects subfield data to be turned on in each corresponding scan line from the subfield data and outputs the detection result as a control signal,
wherein the scan pulse generating unit generates a scan pulse for a scan line according to the control signal,
wherein the address data generating unit outputs the subfield data to an address driving unit according to the control signal.

8. The panel driving device of claim 7, wherein a subfield is omitted when there is no subfield data to be turned on in the scan lines.
